(19) United States
(12) Patent Application Publication
(10) Pub. No.: US 2020/0412120 A1
(43) Pub. Date: Dec. 31, 2020

(54) SPLICED SHIELDED WIRE CABLE AND METHOD OF MANUFACTURING SAME

(71) Applicant: Delphi Technologies, Inc., Troy, MI (US)

(72) Inventors: Thomas A. Volpone, Cortland, OH (US); Bruce D. Taylor, Cortland, OH (US); Troy A. Iler, Salem, OH (US); Eric B. Poma, Hubbard, OH (US)

(21) Appl. No.: 16/606,237

(22) PCT Filed: Apr. 17, 2018
(86) PCT No.: PCT/US2018/027875

§ 371 Date: Oct. 18, 2019

Related U.S. Application Data
(60) Provisional application No. 62/502,067, filed on May 5, 2017.

(51) Int. Cl. H02G 15/18; H01B 7/00; H02G 1/00; H02G 15/013; H01R 4/02

(52) U.S. Cl. CPC H02G 15/1806; H01B 7/0045; H01R 4/02; H02G 15/013; H02G 1/005

(57) ABSTRACT

A wire harness assembly including a first, second, and third shielded wire cable, each having a core conductor surrounded by a shield conductor which is surrounded by a insulative jacket. Portions of the core conductors are sonically welded to one another. The assembly also includes a flexible insulative layer wrapped about the sonically welded core portions, a flexible conductive layer wrapped about the flexible insulative layer and exposed shield portions, and a section of heat shrink tubing in which the flexible conductive layer and portions of the insulative jackets are enclosed. The assembly further including an insulative housing having a longitudinal cavity extending therethrough in which the section of heat shrink tubing, the flexible conductive layer, and portions of the insulative jackets are disposed.

### CROSS-REFERENCE TO RELATED APPLICATION

This application is a national stage application under 35 U.S.C. § 371 of PCT Application Number PCT/US18/27875 having an international filing date of Apr. 17, 2018, which designated the United States, said PCT application claiming the benefit of U.S. Provisional Patent Application No. 62/502,067 filed on May 5, 2017, the entire disclosure of each which is hereby incorporated by reference.

### INCORPORATION BY REFERENCE

The entire disclosure of U.S. Pat. No. 9,543,747 is hereby incorporated herein by reference.

### TECHNICAL FIELD OF THE INVENTION

The invention generally relates to a method for splicing shielded wire cables and the spliced wire cables produced by this method.

### BRIEF DESCRIPTION OF THE SEVERAL VIEWS OF THE DRAWING

The present invention will now be described, by way of example with reference to the accompanying drawings, in which:

FIG. 1 is an illustration of a wire harness assembly having several shielded wire cables spliced together in accordance an embodiment of the invention;

FIG. 2 is an illustration of a wire harness assembly having a core conductor splice connection in accordance with an embodiment of the invention;

FIG. 3 is an illustration of a wire harness assembly having a flexible insulative layer wrapped about the spliced shielded wire cable of FIG. 2 in accordance with an embodiment of the invention;

FIG. 4 is an illustration of a wire harness assembly having a flexible conductive layer wrapped about the exposed shield conductors of the shielded wire cables of FIG. 3 in accordance with an embodiment of the invention;

FIG. 5 is an illustration of a wire harness assembly having a section of heat shrink tubing wrapped about the flexible conductive layer of FIG. 4 in accordance with an embodiment of the invention;

FIG. 6 is an illustration of the wire harness assembly of FIG. 5 being inserted within a cavity of an insulative housing in accordance with an embodiment of the invention;

FIG. 7 is an illustration of the wire harness assembly of FIG. 6 prior to insertion of the seals within the housing and the attachment the retainer caps to the housing in accordance with an embodiment of the invention; and

FIG. 8 is a flowchart of a process of forming a wire harness assembly in accordance with another embodiment of the invention.

### DETAILED DESCRIPTION OF THE INVENTION

Reference will now be made in detail to embodiments, examples of which are illustrated in the accompanying drawings. In the following detailed description, numerous specific details are set forth in order to provide a thorough understanding of the various described embodiments. However, it will be apparent to one of ordinary skill in the art that the various described embodiments may be practiced without these specific details. In other instances, well-known methods, procedures, components, circuits, and networks have not been described in detail so as not to unnecessarily obscure aspects of the embodiments.

Described herein are devices and methods for splicing two or more shielded wire cables. The devices and methods may be used to splice shielded wire cables with a single core conductor or multiple core connectors. The devices and methods described herein may be used to splice together two shield wire cables, for example to repair a cut cable. The devices and methods described herein may also be used to splice one shielded wire cable to two or more shielded wire cables to form a Y-splice or H-splice. The devices and methods described herein may be used for splicing a variety of shielded wire cables types, for example shielded wire cables for communication transmissions, such as RG-59 cable, or high voltage shielded wire cables designed for electrical or hybrid electrical vehicles.

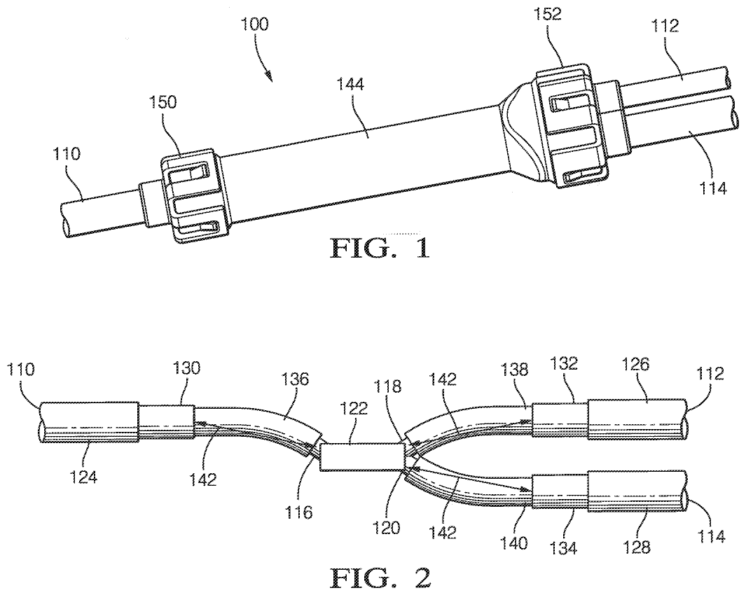

FIG. 1 illustrates a wire harness assembly 100 having three shielded wire cables 110, 112, 114 that are spliced together. The spliced portion is protected by a tubular insulative housing 144.

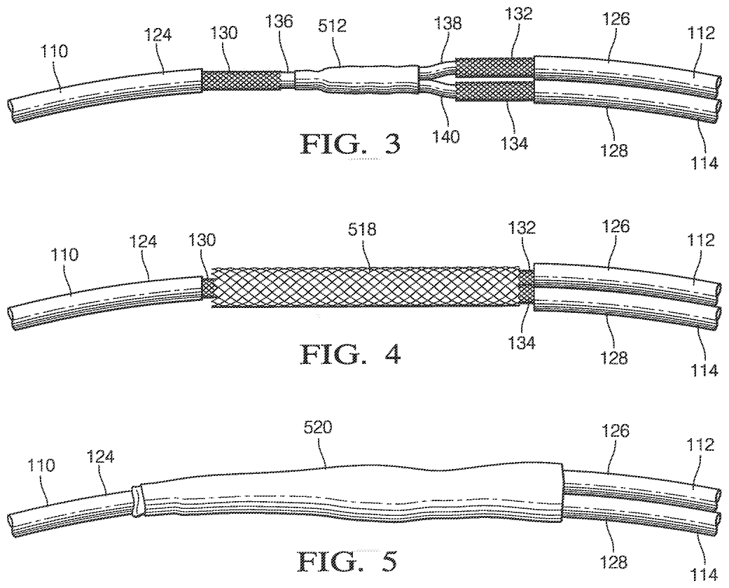

FIG. 3 illustrates an example of three high voltage shielded wire cables a first shielded cable 110, a second shielded cable 112, and a third shielded cable 114 that have been spliced together. A core conductor 116, 118, 120 of each of the shielded cables 110, 112, 114 has been joined by a sonic welding process to form a connection 122. Portions of the outer insulation layers 124, 126, 128, shield conductors 130, 132, 134, and inner insulation layers 136, 138, 140 have been removed from the core conductors 116, 118, 120 prior forming the connection 122. Alternatively, other processes well known to those skilled in the art, such as soldering or crimping the conductors within a conductive sleeve may be used to form the connection 122. An additional portion of each of the shield conductors 130, 132, 134 may be removed or cut way to provide adequate voltage creepage distance 142 to prevent a leakage current between the core conductors 116, 118, 120 and the shield conductors 130, 132, 134, thereby exposing the inner insulation layers 136, 138, 140 of the shielded cables 110, 112, 114.

As illustrated in FIG. 3, a flexible insulation layer 512 is wrapped about the joined portion 122 and the exposed portions of the core conductors 116, 118, 120 so as to completely cover and enclose the exposed portions of the core conductors 116, 118, 120 while leaving the shield conductors 130, 132, 134 exposed as shown in FIG. 3. The flexible insulation layer 512 may be formed of a flexible dielectric material such as heat shrinkable plastic tubing, cloth tape, or plastic tape.

As shown in FIG. 4, a flexible conductive layer 518 is wrapped about the flexible insulation layer 512 and over at least a portion of the exposed shield conductors 130, 132, 134 so that it is electrical contact with all of the shield conductors 130, 132, 134 as shown in FIG. 4. The flexible conductive layer 518 is preferably not in contact with the outer insulation layers 124, 126, 126 of the shielded wire cables 110, 112, 114. This flexible conductive layer 518 may be a sleeve of braided copper wires or a metal foil.

As illustrated in FIG. 5, a section of thermoplastic heat shrink tubing 520 is applied over the flexible conductive layer 518 and heated so that it is in compressive contact with the flexible conductive layer 518 and portions of the outer insulation layers 124, 126, 126 of the shielded wire cables 110, 112, 114. The heat shrink tubing 520 sealably engages the outer insulation layers 124, 126, 128 of at least one of the shielded wire cables 110, 112, 114 and encloses the flexible conductive layer 518 as shown in FIG. 5. As used herein, sealably engaged means that the heat shrink tubing 520 will resist contaminants, such as dust, dirt, or fluids, from entering between the outer insulation layers 124, 126, 128 and the heat shrink tubing 520. It does not mean that it provides a hermetic seal. Suitable compositions and sources of heat shrink tubing are well known to those skilled in the art. The heat shrink tubing 520 may be preloaded onto the blunt cut single shielded wire cable 110 prior to forming the connection 122. Other embodiments of the invention may be envisioned in which the heat shrink tubing is replaced by another dielectric material such as cloth tape, plastic tape, or a conformal coating, such as a silicone-based material, applied over the flexible conductive layer 518 and shielded wire cables 110, 112, 114.

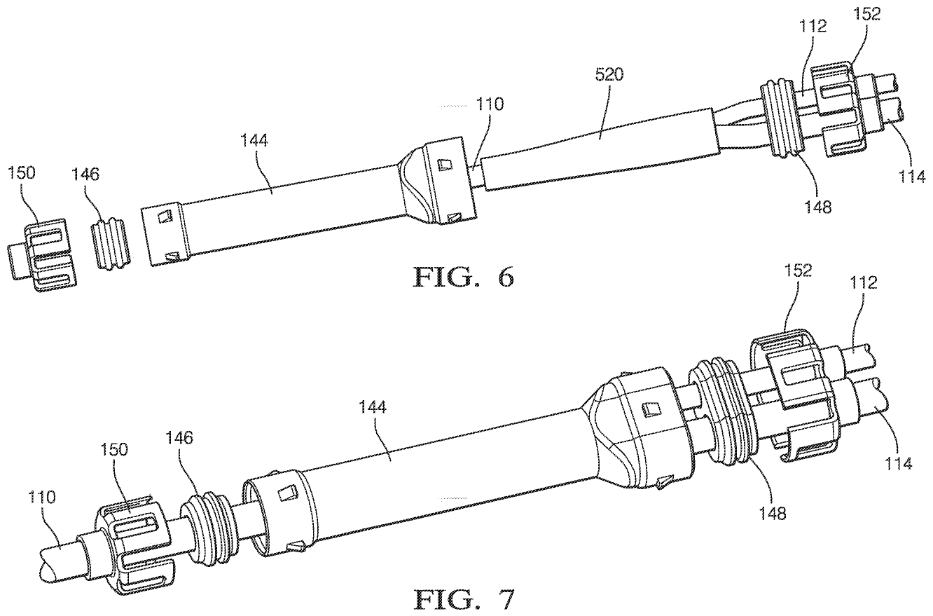

As illustrated in FIGS. 6 and 7, the spliced wire cables with the heat shrink tubing 520 applied are placed within a longitudinal cavity of an insulative housing 144 formed of a dielectric material such as polybutylene terephthalate (PBT) or polyamide (PA, NYLON). A single wire seal 146 formed of a compliant material, such as a silicone-based rubber is applied to the first shielded cable 110 and a dual wire seal 148 also formed of a compliant material is applied to the second and third shielded cables 112, 114 and then inserted within the cavity of the housing 144 such that the first and second wire seals 146, 148 are in sealably engaged with the wire cables and an inner surface of the cavity. Seal retainers 150, 152 are attached to the housing 144 and hold the first and second wire seals 146, 148 within the housing 144.

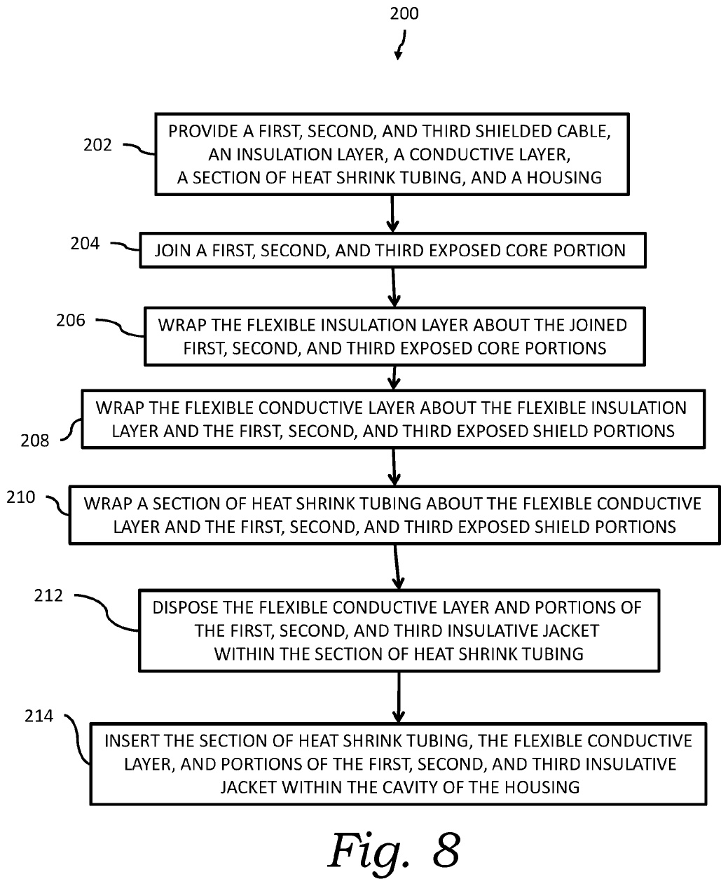

FIG. 8 illustrates a non-limiting method 200 of splicing shielded wire cables 110, 112, 114 together. The method 200 includes the following steps.

STEP 202, PROVIDE A FIRST, SECOND, AND THIRD SHIELDED CABLE, AN INSULATION LAYER, A CONDUCTIVE LAYER, A SECTION OF HEAT SHRINK TUBING, AND A HOUSING, includes providing a first shielded cable 110 having a first core conductor 116 at least partially axially surrounded by a first shield conductor 130 which is at least partially axially surrounded by a first insulative jacket 124, the first core conductor 116 having a first exposed core portion and the first shield conductor 130 having a first exposed shield portion, providing a second shielded wire cable 112 having a second core conductor 118 at least partially axially surrounded by a second shield conductor 132 which is at least partially axially surrounded by a second insulative jacket 126, the second core conductor 118 having a second exposed core portion and the second shield conductor 132 having a second exposed shield portion, providing a third shielded wire cable 114 having a third core conductor 120 at least partially axially surrounded by a third shield conductor 134 which is at least partially axially surrounded by a third insulative jacket 128, the third core conductor 120 having a third exposed core portion and the third shield conductor 134 having a third exposed shield portion, providing a flexible insulation layer 512, providing a flexible conductive layer 518, providing a section of heat shrink tubing 520, and providing an insulative housing 144 having a longitudinal cavity extending therethrough;

STEP 204, JOIN A FIRST, SECOND, AND THIRD EXPOSED CORE PORTION, includes joining 122 the first, second, and third exposed core portions using a sonic welding process;

STEP 206, WRAP THE FLEXIBLE INSULATION LAYER ABOUT THE JOINED FIRST, SECOND, AND THIRD EXPOSED CORE PORTIONS, includes wrapping the flexible insulation layer 512 about the joined first, second, and third exposed core portions;

STEP 208, WRAP THE FLEXIBLE CONDUCTIVE LAYER ABOUT THE FLEXIBLE INSULATION LAYER AND THE FIRST, SECOND, AND THIRD EXPOSED SHIELD PORTIONS, includes wrapping the flexible conductive layer 518 about the flexible insulation layer 512 and the first, second, and third exposed shield portions;

STEP 210, WRAP A SECTION OF HEAT SHRINK TUBING ABOUT THE FLEXIBLE CONDUCTIVE LAYER AND THE FIRST, SECOND, AND THIRD EXPOSED SHIELD PORTIONS, includes wrapping a section of heat shrink tubing 520 about the flexible conductive layer 518 and the first, second, and third exposed shield portions;

STEP 212, DISPOSE THE FLEXIBLE CONDUCTIVE LAYER AND PORTIONS OF THE FIRST, SECOND, AND THIRD INSULATIVE JACKET WITHIN THE SECTION OF HEAT SHRINK TUBING, includes disposing the flexible conductive layer 518 and portions of the first, second, and third insulative jacket 124, 126 128 within the section of heat shrink tubing 520;

STEP 214, INSERT THE SECTION OF HEAT SHRINK TUBING, THE FLEXIBLE CONDUCTIVE LAYER, AND PORTIONS OF THE FIRST, SECOND, AND THIRD INSULATIVE JACKET WITHIN THE CAVITY OF THE HOUSING, includes inserting the section of heat shrink tubing 520, the flexible conductive layer 518, and portions of the first, second, and third insulative jacket 124, 126, 128 within the cavity of the housing 144;

STEP 216, PROVIDE A FIRST AND SECOND COMPLAINT SEAL, is an optional step that includes providing a first compliant seal 146 and a second compliant seal 148;

STEP 218, DISPOSE THE FIRST AND SECOND COMPLAINT SEAL WITHIN THE CAVITY, is an optional step that includes disposing the first compliant seal 146 within the longitudinal cavity of the housing 144 intermediate the first insulative jacket 124 and the housing 144 and disposing the second compliant seal 148 within the longitudinal cavity of the housing 144 intermediate the second insulative jacket 126, the third insulative jacket 128, and the housing 144;

STEP 220, PROVIDE A FIRST AND SECOND RETAINER CAP, is an optional step that includes providing a first retainer cap 150 and a second retainer cap 152; and

STEP 222, AFFIX THE FIRST AND SECOND RETAINER CAP TO THE HOUSING, is an optional step that includes affixing the first retainer cap 150 to the housing 144, thereby retaining the first compliant seal 146 within the housing 144 and affixing the second retainer cap 152 to the housing 144, thereby retaining the second compliant seal 148 within the housing 144.

Accordingly, a shielded wire harness assembly 100 and a method 200 of splicing a plurality of shielded wire cables 110, 112, 114 are provided. The wire harness assembly 100 and method 200 eliminates need for ferrules on the shielded cables 110, 112, 114 and reduces the package size of the previous housing designs, while still providing a hard shell housing 144 with provisions for attachment clips as is preferred by automotive original equipment manufacturers (OEMs). The housing 144 protects the welded cores 122 from surface damage from sharp objects in vehicle mounting conditions and allows processing with existing welding equipment.

While this invention has been described in terms of the preferred embodiments thereof, it is not intended to be so limited, but rather only to the extent set forth in the claims that follow. For example, the above-described embodiments (and/or aspects thereof) may be used in combination with each other. In addition, many modifications may be made to configure a particular situation or material to the teachings of the invention without departing from its scope. Dimensions, types of materials, orientations of the various components, and the number and positions of the various components described herein are intended to define parameters of certain embodiments, and are by no means limiting and are merely prototypical embodiments.

Many other embodiments and modifications within the spirit and scope of the claims will be apparent to those of skill in the art upon reviewing the above description. The scope of the invention should, therefore, be determined with reference to the following claims, along with the full scope of equivalents to which such claims are entitled.

As used herein, ‘one or more’ includes a function being performed by one element, a function being performed by more than one element, e.g., in a distributed fashion, several functions being performed by one element, several functions being performed by several elements, or any combination of the above.

It will also be understood that, although the terms first, second, etc. are, in some instances, used herein to describe various elements, these elements should not be limited by these terms. These terms are only used to distinguish one element from another. For example, a first contact could be termed a second contact, and, similarly, a second contact could be termed a first contact, without departing from the scope of the various described embodiments. The first contact and the second contact are both contacts, but they are not the same contact.

The terminology used in the description of the various described embodiments herein is for the purpose of describing particular embodiments only and is not intended to be limiting. As used in the description of the various described embodiments and the appended claims, the singular forms “a”, “an” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, the term “if” is, optionally, construed to mean “when” or “upon” or “in response to determining” or “in response to detecting,” depending on the context. Similarly, the phrase “if it is determined” or “if [a stated condition or event] is detected” is, optionally, construed to mean “upon determining” or “in response to determining” or “upon detecting [the stated condition or event]” or “in response to detecting [the stated condition or event],” depending on the context.

Additionally, while terms of ordinance or orientation may be used herein these elements should not be limited by these terms. All terms of ordinance or orientation, unless stated otherwise, are used for purposes distinguishing one element from another, and do not denote any particular order, order of operations, direction or orientation unless stated otherwise.

1. A wire harness assembly, comprising:
a first shielded wire cable having a first core conductor at least partially axially surrounded by a first shield conductor which is at least partially axially surrounded by a first insulative jacket, the first core conductor having a first exposed core portion and the first shield conductor (130) having a first exposed shield portion;
a second shielded wire cable having a second core conductor at least partially axially surrounded by a second shield conductor which is at least partially axially surrounded by a second insulative jacket, the second core conductor having a second exposed core portion and the second shield conductor having a second exposed shield portion;
a third shielded wire cable having a third core conductor at least partially axially surrounded by a third shield conductor which is at least partially axially surrounded by a third insulative jacket (128), the third core conductor (120) having a third exposed core portion and the third shield conductor having a third exposed shield portion, wherein the first exposed core portion is sonically welded to the first exposed core portion and the first exposed core portion;
a flexible insulative layer wrapped about the sonically welded first, second, and third exposed core portions;
a flexible conductive layer wrapped about the flexible insulative layer and the first, second, and third exposed shield portions;
a section of heat shrink tubing in which the flexible conductive layer and portions of the first, second, and third insulative jackets are enclosed; and
an insulative housing having a longitudinal cavity extending therethrough in which the section of heat shrink tubing, the flexible conductive layer (518), and portions of the first, second, and third insulative jackets are disposed.

2. The wire harness assembly according to claim 1, wherein the flexible conductive layer is formed of braided wire strands.

3. The wire harness assembly according to claim 1, further comprising:
a first compliant seal disposed within the longitudinal cavity intermediate the first insulative jacket and the insulative housing; and
a second compliant seal disposed within the longitudinal cavity intermediate the second insulative jacket, the third insulative jacket, and the insulative housing.

4. The wire harness assembly according to claim 3, further comprising:
a first retainer cap attached to the insulative housing configured to retain the first compliant seal within the insulative housing; and
a second retainer cap attached to the insulative housing configured to retain the second compliant seal within the insulative housing.

5. A method of forming a wire harness assembly,
comprising the steps of:
providing a first shielded wire cable having a first core conductor at least partially axially surrounded by a first shield conductor which is at least partially axially surrounded by a first insulative jacket, the first core conductor having a first exposed core portion and the first shield conductor having a first exposed shield portion;
providing a second shielded wire cable having a second core conductor at least partially axially surrounded by a second shield conductor which is at least partially axially surrounded by a second insulative jacket, the second core conductor having a second exposed core portion and the second shield conductor having a second exposed shield portion;
providing a third shielded wire cable having a third core conductor at least partially axially surrounded by a third shield conductor which is at least partially axially surrounded by a third insulative jacket (128), the third core conductor having a third exposed core portion and the third shield conductor having a third exposed shield portion;
providing a flexible insulation layer;
providing a flexible conductive layer;
providing a section of heat shrink tubing;
providing an insulative housing having a longitudinal cavity extending therethrough;
joining the first, second, and third exposed core portions using a sonic welding process;
wrapping the flexible insulation layer about the joined first, second, and third exposed core portions;
wrapping the flexible conductive layer about the flexible insulation layer and the first, second, and third exposed shield portions;
wrapping the section of heat shrink tubing (520) about the flexible conductive layer and the first, second, and third exposed shield portions;
disposing the flexible conductive layer and portions of the first, second, and third insulative jacket within the section of heat shrink tubing;
inserting the section of heat shrink tubing, the flexible conductive layer, and portions of the first, second, and third insulative jacket within the longitudinal cavity of the insulative housing.

6. The method according to claim 5, wherein the flexible conductive layer is formed of braided wire strands.

7. The method according to claim 5, further comprising the steps of:
providing a first compliant seal and a second compliant seal;
disposing the first compliant seal within the longitudinal cavity intermediate the first insulative jacket and the insulative housing; and
disposing the second compliant seal within the longitudinal cavity intermediate the second insulative jacket, the third insulative jacket, and the insulative housing.

8. The method according to claim 7, further comprising the steps of:
providing a first retainer cap and a second retainer cap;
affixing the first retainer cap to the insulative housing, thereby retaining the first compliant seal within the insulative housing; and
affixing the second retainer cap to the insulative housing thereby, retaining the second compliant seal within the insulative housing.

9. A wire harness assembly, comprising:
a first shielded wire cable having a first core conductor at least partially axially surrounded by a first shield conductor which is at least partially axially surrounded by a first insulative jacket, the first core conductor having a first exposed core portion and the first shield conductor having a first exposed shield portion;
a second shielded wire cable having a second core conductor at least partially axially surrounded by a second shield conductor which is at least partially axially surrounded by a second insulative jacket, the second core conductor having a second exposed core portion and the second shield conductor having a second exposed shield portion;
a third shielded wire cable having a third core conductor at least partially axially surrounded by a third shield conductor which is at least partially axially surrounded by a third insulative jacket, the third core conductor having a third exposed core portion and the third shield conductor having a third exposed shield portion, wherein the first exposed core portion is sonically welded to the first exposed core portion and the first exposed core portion;
a means for electrically insulating the sonically welded first, second, and third exposed core portions;
a means for providing an electrically conductive path between the first, second, and third exposed shield portions;
a section of heat shrink tubing in which the means for providing an electrically conductive path between the first, second, and third exposed shield portions and the means for electrically insulating the sonically welded first, second, and third exposed core portions are at least partially enclosed; and
a means for housing the means for electrically insulating the sonically welded first, second, and third exposed core portions, the means for providing an electrically conductive path between the first, second, and third exposed shield portions, and the section of heat shrink tubing.

10. The wire harness assembly according to claim 9, wherein the means for providing an electrically conductive path between the first, second, and third exposed shield portions is formed of braided wire strands.

11. The wire harness assembly according to claim 9, further comprising a means for sealing the means for housing the means for electrically insulating the sonically welded first, second, and third exposed core portions, the means for providing an electrically conductive path between the first, second, and third exposed shield portions, and the section of heat shrink tubing.

12. The wire harness assembly according to claim 11, further comprising a retaining means for securing the sealing means within the housing means.
